(19) United States
(12) Patent Application Publication
(10) Pub. No.: US 2022/0401769 A1
(43) Pub. Date: Dec. 22, 2022

(54) SYSTEMS AND METHODS FOR SUPPRESSING FIRE IN AN ENCLOSED COMPONENT WITHIN A VEHICLE

(71) Applicant: THE BOEING COMPANY, CHICAGO, IL (US)

(72) Inventors: Darren Carl McIntosh, Mukilteo, WA (US); Alfred R. Carlo, Bothell, WA (US)

(73) Assignee: THE BOEING COMPANY, CHICAGO, IL (US)

(21) Appl. No.: 17/894,225

(22) Filed: Aug. 24, 2022

Related U.S. Application Data
(63) Continuation-in-part of application No. 17/720,401, filed on Apr. 14, 2022.
(60) Provisional application No. 63/213,238, filed on Jun. 22, 2021.
(60) Provisional application No. 63/290,739, filed on Dec. 17, 2021.

(51) Int. Cl. A62C 3/08; A62C 2/06; B64D 11/04; B64D 11/02

(52) U.S. Cl. CPC A62C 3/08; A62C 2/065; B64D 11/04; B64D 11/02

(57) ABSTRACT

A vehicle includes an internal cabin. An enclosed component is within the internal cabin. The enclosed component includes an intumescent coating. As an example, the enclosed component is a lavatory within the internal cabin. As another example, the enclosed component is a waste compartment. As another example, the enclosed component is a grille within a door.

### CROSS-REFERENCE TO RELATED APPLICATIONS

This application is a continuation-in-part of U.S. patent application Ser. No. 17/720,401, filed Apr. 14, 2022, which relates to and claims priority benefits from U.S. Provisional Patent Application No. 63/213,238, filed Jun. 22, 2021, each of which is hereby incorporated by reference in its entirety.

This application also relates to and claims priority benefits from U.S. Provisional Patent Application No. 63/290,739, filed Dec. 17, 2021, which is hereby incorporated by reference in its entirety

### FIELD OF THE DISCLOSURE

Examples of the present disclosure generally relate to systems and methods for suppressing fire in an enclosed space, such as within a lavatory, a galley, a stowage bin, or the like within an internal cabin of a vehicle, such as a commercial aircraft.

### BACKGROUND OF THE DISCLOSURE

Commercial aircraft are used to transport passengers between various locations. A typical commercial aircraft includes one or more lavatories within an internal cabin.

Airline customers are increasingly requesting the use of lavatories to store excess bagged trash. Multiple bags of trash may be stowed in one or more lavatories when the internal cabin is being prepared for landing and the lavatories are locked and unused.

Certain regulations, such as promulgated by the U.S. Federal Aviation Administration (FAA), require lavatories within commercial aircraft to be able to contain a fire therein in less than 30 minutes. Indeed, the FAA has strict requirements in relation to such fire containment. Testing for such requirements typically includes ignition of multiple bags of trash (for example, four large bags of trash).

Further, certain regulations also require a lavatory door of a commercial aircraft to have an open grille in order to satisfy certain decompression requirements. The open grille also allows negative air flow pressure within the lavatory, to prevent odors escaping into the main cabin. The fire containment and the decompression requirements can conflict, as the open grille allows air to pass therethrough and potentially feed a fire, as demonstrated during certain tests. Known lavatory doors include grilles that are always open, and therefore create an uninterrupted flow of air into any fire within the lavatory.

### SUMMARY OF THE DISCLOSURE

A need exists for a system and method for effectively and efficiently suppressing fire within an enclosed component, such as a lavatory, a galley, a stowage bin, a closet, or the like of a vehicle, such as a commercial aircraft.

With that need in mind, certain examples of the present disclosure provide a vehicle including an internal cabin. An enclosed component is within the internal cabin. The enclosed component includes an intumescent coating.

In at least one example, the intumescent coating covers at least a portion of one or both of an internal or an external surface of the enclosed component.

In at least one example, the intumescent coating covers an entirety of the enclosed component.

As an example, the enclosed component is an oven compartment within a galley. As another example, the enclosed component is a lavatory. As another example, the enclosed component is a waste compartment within a lavatory. As another example, the enclosed component is a grille within a door of a lavatory. As a further example, the grille has an intumescent inner grille that includes the intumescent coating. As another example, the enclosed component is a sidewall, at least a portion of a monument, or the like. As another example, the enclosed component is a battery. As another example, a window tube between the lavatory and the aircraft window includes an intumescent coating. As another example, inside surfaces of an overhead stowage bin include an intumescent coating.

Certain examples of the present disclosure provide a fire suppression method for a vehicle. The fire suppression method includes coupling an intumescent coating to an enclosed component within an internal cabin of the vehicle.

In at least one example, said coupling includes covering at least a portion of one or both of an internal or an external surface of the enclosed component with the intumescent coating.

In at least one example, said coupling comprises covering an entirety of the enclosed component with the intumescent coating.

### BRIEF DESCRIPTION OF THE DRAWINGS

FIG. 1 illustrates a perspective front view of an aircraft, according to an embodiment of the present disclosure.

FIG. 2 illustrates a perspective internal view of a lavatory, according to an embodiment of the present disclosure.

FIG. 3 illustrates a schematic block diagram of a fire suppression system for a lavatory within an internal cabin of an aircraft, according to an embodiment of the present disclosure.

FIG. 4 illustrates a flow chart of a fire suppression method for a lavatory within an internal cabin of an aircraft, according to an embodiment of the present disclosure.

FIG. 5 illustrates an isometric front view of a door having a grille, according to an embodiment of the present disclosure.

FIG. 6 illustrates an isometric exploded view of a fire suppression system, according to an embodiment of the present disclosure.

FIG. 7 illustrates an isometric view of the fire suppression system of FIG. 6.

FIG. 8 illustrates a lateral view of the fire suppression system having the temperature-responsive device in a first state during normal operation, according to an embodiment of the present disclosure.

FIG. 9 illustrates a lateral view of the fire suppression system as a predetermined temperature threshold is reached, according to an embodiment of the present disclosure.

FIG. 10 illustrates a lateral view of the fire suppression system having the temperature-responsive device in a second state after the predetermined temperature threshold is reached, according to an embodiment of the present disclosure.

FIG. 11A illustrates an isometric view of a fire suppression system, according to an embodiment of the present disclosure.

FIG. 11B illustrates a top edge view of the fire suppression system of FIG. 11A.

FIG. 12 illustrates an isometric view of a door having the fire suppression system, according to an embodiment of the present disclosure.

FIG. 13 illustrates a lateral view of the fire suppression system having the temperature-responsive device in a first state during normal operation, according to an embodiment of the present disclosure.

FIG. 14 illustrates a lateral view of the fire suppression system as a predetermined temperature threshold is reached, according to an embodiment of the present disclosure.

FIG. 15 illustrates a lateral view of the fire suppression system having the temperature-responsive device in a second state after the predetermined temperature threshold is reached, according to an embodiment of the present disclosure.

FIG. 16 illustrates a lateral view of the fire suppression system having the temperature-responsive device in a first state during normal operation, according to an embodiment of the present disclosure.

FIG. 17 illustrates a lateral view of the fire suppression system as a predetermined temperature threshold is reached, according to an embodiment of the present disclosure.

FIG. 18 illustrates a lateral view of the fire suppression system having the temperature-responsive device in a second state after the predetermined temperature threshold is reached, according to an embodiment of the present disclosure.

FIG. 19 illustrates a flow chart of a fire suppression method, according to an embodiment of the present disclosure.

FIG. 20 illustrates a schematic block diagram of an aircraft, according to an example of the present disclosure.

FIG. 21 illustrates a flow chart of a method of suppressing fire within an internal cabin of a vehicle, according to an example of the present disclosure.

FIG. 22 illustrates a schematic block diagram of an enclosed component in a normal state of operation, according to an example of the present disclosure.

FIG. 23 illustrates a schematic block diagram of the enclosed component as a fire ignites therein.

FIG. 24 illustrates a schematic block diagram of the enclosed component having an intumescent coating in an expanded state.

FIG. 25 illustrates an isometric external view of a lavatory.

FIG. 26 illustrates an isometric internal view of a lavatory.

FIG. 27 illustrates a perspective view of an oven compartment within a galley.

FIG. 28 illustrates an isometric view of an outboard face of a monument (for example, a galley, a lavatory, or the like) of an internal cabin.

FIG. 29 illustrates an isometric view of a battery box casing.

FIG. 30 illustrates a schematic block diagram of an aircraft, according to an example of the present disclosure.

FIG. 31 illustrates a front view of an intumescent inner grille, according to an example of the present disclosure.

FIG. 32 illustrates a lateral view of a fire suppression in a first state during normal operation, according to an example of the present disclosure.

FIG. 33 illustrates a lateral view of the fire suppression system as a predetermined temperature threshold is reached, according to an example of the present disclosure.

FIG. 34 illustrates a lateral view of the fire suppression system in a second state after the predetermined temperature threshold is reached, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Certain examples of the present disclosure provide a system and a method for suppressing fire within an enclosed component of a vehicle. In at least one example, the enclosed component is a lavatory.

In at least one example, the lavatory includes a louver grille system that allows two independent modes of operation specific to an aircraft. First, the louver grille system permits airflow in a decompression event, while also allowing airflow to maintain negative air pressure within the lavatory. Second, in response to a particular set of circumstances (for example, a predetermined temperature range) the system is automatically configured to change its state (closeout louver grille) of operation to a fire suppression mechanism. In at least one example, the louver grille system includes an intumescent coating configured to activate at a predetermined temperature threshold or range. As an example, the intumescent coating is configured to meet a requirement for 30 minute fire containment, which is unique to airplane certification. In at least one example, the louver grille system having at least one surface coated with intumescent material is configured for airplane certification in relation to flammability, air pressure differentials, a decompression event, temperature differentials in normal operation as well as during the event of a fire within the lavatory, vibration, reliability, endurance, abuse and fail safe, and/or the like.

Certain examples of the present disclosure provide a lavatory air grille assembly including an air grille component having an intumescent coating configured to eliminate airflow through the grille in the event of a fire in the lavatory (for example, the coating expands and restricts airflow through normally-open grille openings).

Certain examples of the present disclosure provide interiors assemblies having intumescent coatings applied at various locations/openings to seal off the areas in the event of a fire.

Certain examples of the present disclosure provide a vehicle (such as a commercial aircraft) including an internal cabin. A lavatory is within the internal cabin. The lavatory includes a door having a grille and a fire suppression system coupled to the grille. In at least one example, the fire suppression system is or otherwise includes an intumescent coating.

In at least one example, the fire suppression system includes a first inner gate, a second inner gate coupled to the first inner gate to define an air channel therethrough, and a temperature-responsive device coupled to one or both of the first inner gate or the second inner gate. The temperature-responsive device is in a first state below a predetermined temperature threshold, and a second state above the predetermined temperature threshold. In the second state, the second inner gate is moved relative to the first inner gate to close the air channel.

As an example, the temperature-responsive device includes a eutectic alloy fusible link. As an example, the temperature-responsive device includes a button, and a thermoplastic pin extending into the button.

In at least one example, the first inner gate includes a fixed open frame, and the second inner gate includes a louver moveably coupled to the fixed open frame.

Certain examples of the present disclosure provide an entry door for a lavatory of a commercial aircraft that includes a fire suppression system. In at least one example, the fire prevention system includes a louver, or gated system that allows two independent modes of operation specific to the aircraft. A first mode allows the lavatory door grille to permit airflow in a decompression event, while also allowing airflow to maintain negative air pressure within the lavatory. A second mode is configured to automatically change state in response to one or more circumstances (such as a predetermined temperature threshold or range). In particular, in the second mode, the louver or gate automatically closes to prevent airflow into the lavatory.

In at least one example, the fire suppression system includes a eutectic alloy fusible link that is configured to activate at a precise predetermined temperature threshold. For example, the link can be configured to meet the FAA requirement for 30 minute fire containment, which is unique to aircraft certification. In at least one example, the fire suppression system is configured to meet the unique requirements for airplane certification, such as with respect to flammability, air pressure differentials, a decompression event, temperature differentials in normal operation as well as during the event of a fire within the lavatory, vibration, reliability, endurance, abuse and fail safe, and the like. Optionally, the fire suppression system can be used on doors of various other enclosed spaces, whether in other vehicles or fixed structures.

In at least one embodiment, the fire suppression system includes a gate/louver that is configured to close in response to a predetermined temperature being reached (such as via operation of the eutectic alloy fusible link), thereby suffocating a fire of airflow. When the temperature is lower than the predetermined temperature, gate/louver is in an open position, thereby addressing decompression and negative airflow requirements.

Certain examples of the present disclosure provide a vehicle including an internal cabin. An enclosed component is within the internal cabin. The enclosed component include an intumescent coating. In at least one example, the intumescent coating covers at least a portion of one or both of an internal or an external surface of the enclosed component. In a further example, the intumescent coating covers an entirety of the enclosed component. As an example, the enclosed component is a waste compartment or an oven compartment within a galley. As another example, the enclosed component is a lavatory. As another example, the enclosed component is a waste compartment within a lavatory. As another example, the enclosed component is a grille within a door of a lavatory. As a further example, the grille has an intumescent inner grille that includes the intumescent coating. As another example, the enclosed component is a sidewall. As another example, the enclosed component is a portion of a monument (such as an outboard face thereof), such as a galley, lavatory, or the like. As another example, the enclosed component is a battery.

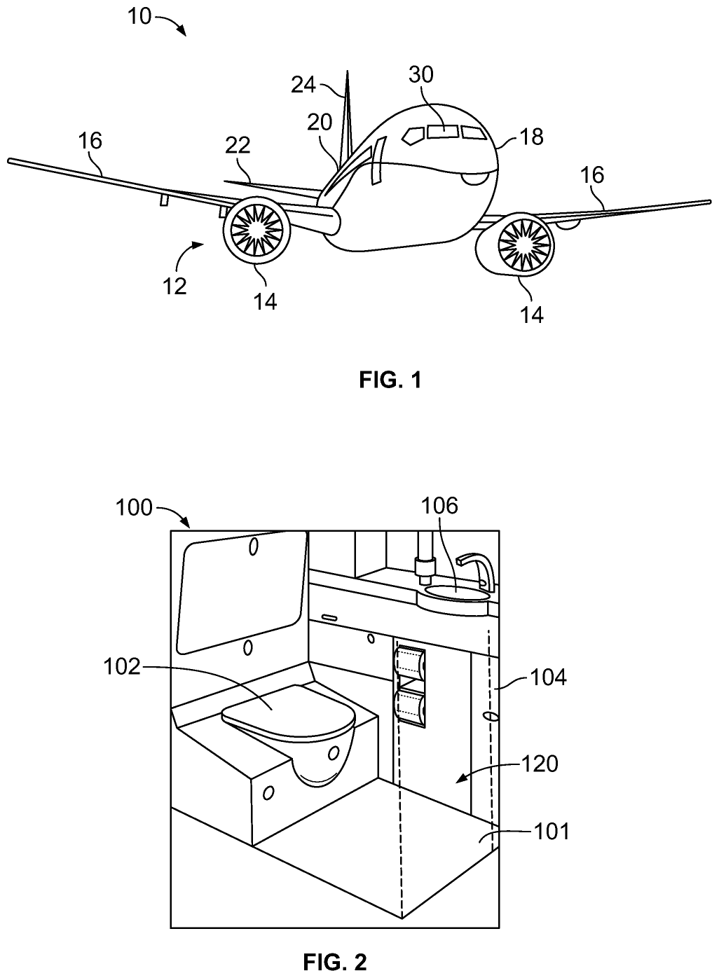

FIG. 1 illustrates a perspective front view of an aircraft 10, according to an embodiment of the present disclosure. The aircraft 10 includes a propulsion system 12 that includes engines 14, for example. Optionally, the propulsion system 12 may include more engines 14 than shown. The engines 14 are carried by wings 16 of the aircraft 10. In other embodiments, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin 30, which includes a flight deck or cockpit, one or more work sections (for example, galleys, personnel carry-on baggage areas, and the like), one or more passenger sections (for example, first class, business class, and coach sections), one or more lavatories, and/or the like. The internal cabin 30 includes numerous enclosed components, such as lavatories, galleys, galley carts, ovens, closets, stowage bin assemblies, and/or the like. At least one of the enclosed components has one or more components that include an intumescent coating. For example, a surface of an enclosed component can be coated with intumescent material. As a further example, at least one of the lavatories within the internal cabin 30 includes a grille system having at least one surface having an intumescent coating.

Alternatively, instead of an aircraft, examples of the present disclosure may be used with various other vehicles, such as automobiles, buses, locomotives and train cars, watercraft, and the like. Further, examples of the present disclosure may be used with respect to fixed structures, such as commercial and residential buildings.

FIG. 2 illustrates a perspective internal view of a lavatory 100, according to an example of the present disclosure. The lavatory 100 is an example of an enclosed component, such as within the internal cabin of the aircraft 10, shown in FIG. 1. The lavatory 100 may be onboard an aircraft, as described above. Optionally, the lavatory 100 may be onboard various other vehicles. In other embodiments, the lavatory 100 may be within a fixed structure, such as a commercial or residential building. The lavatory 100 includes a base floor 101 that supports a toilet 102, cabinets 104, and a sink 106 or wash basin. The lavatory 100 may be arranged differently than shown. The lavatory 100 may include more or less components than shown.

The lavatory 100 also includes an entry door 120. As described herein, the door 120 can include a grille that includes a fire suppression system. In at least one example, the door 120 includes a grille system having at least a portion having an intumescent coating.

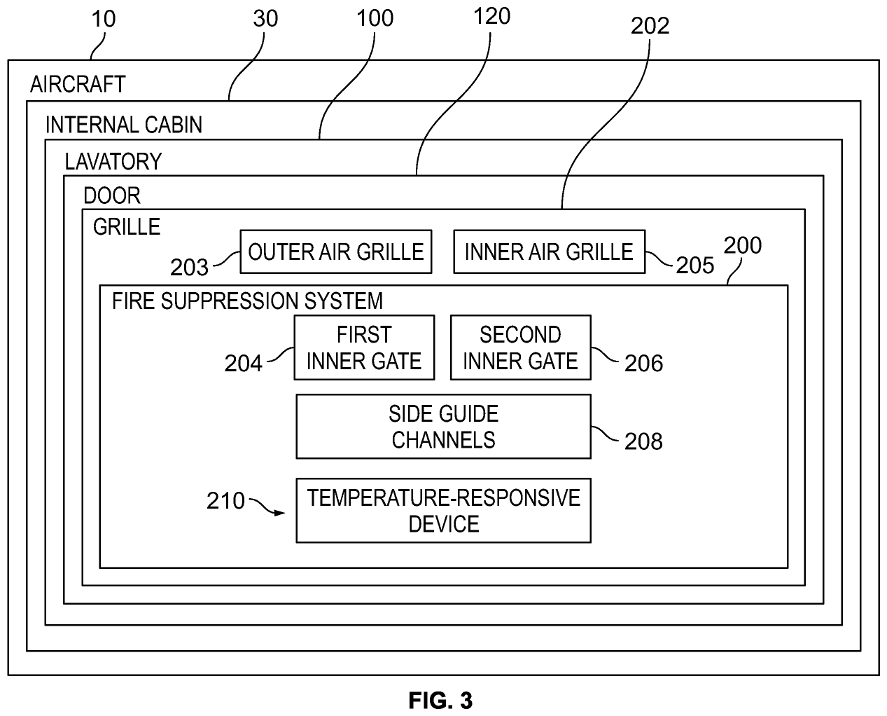

FIG. 3 illustrates a schematic block diagram of a fire suppression system 200 for a lavatory 100 within an internal cabin 30 of an aircraft 10, according to an embodiment of the present disclosure. The fire suppression system 200 is coupled to a grille assembly (or grille) 202 within a door (or panel) 120 of the lavatory 100. The grille 202 can include an outer air grille 203 and an inner air grille 205.

In at least one example, the door 120 can be manufactured having the fire suppression system 200. As another example, a grille of an existing door can be removed, and the door can be retrofit with the grille 202 having the fire suppression system 200.

The fire suppression system 200 includes a first inner gate 204 coupled to a second inner gate 206. For example, the first inner gate 204 is a fixed, stationary gate, and the second inner gate 206 is moveable in relation to the first inner gate 204. Optionally, the first inner gate 204 can be the moveable gate, and the second inner gate 206 can be the fixed, stationary gate. The fire suppression system 200 can also include side guide channels 208 (for example, guide channels formed in lateral rails that support one or both of the first inner gate 204 and/or the second inner gate 206).

A temperature-responsive device 210 is coupled to one or both of the first inner gate 204 and/or the second inner gate 206. The temperature-responsive device 210 is configured to change states in response to a predetermined temperature being reached. In at least one embodiment, the temperature-responsive device 210 is a eutectic alloy fusible link. The predetermined temperature can be a temperature at which fire ignites within the lavatory 100. For example, the predetermined temperature can be a temperature determined by the FAA in relation to one or more fire suppression regulations.

In operation, when the temperature within the lavatory 100 is below the predetermined temperature, the temperature-response device 210 is in a first state, and maintains the first gate 204 and the second gate 206 in an open position, such that one or more air channels are open therethrough and allow air to pass into the lavatory 100. In response to the predetermined temperature being reached (that is, a predetermined temperature threshold), the temperature-responsive device 210 automatically changes to a second state (such as by melting). In at least one example, the second inner gate 206 is moveably coupled to the temperature-responsive device 210. As the temperature-responsive device 210 changes to the second state, the second inner gate 206 moves in response thereto, thereby closing the one or more air channels, and preventing airflow into the lavatory 100.

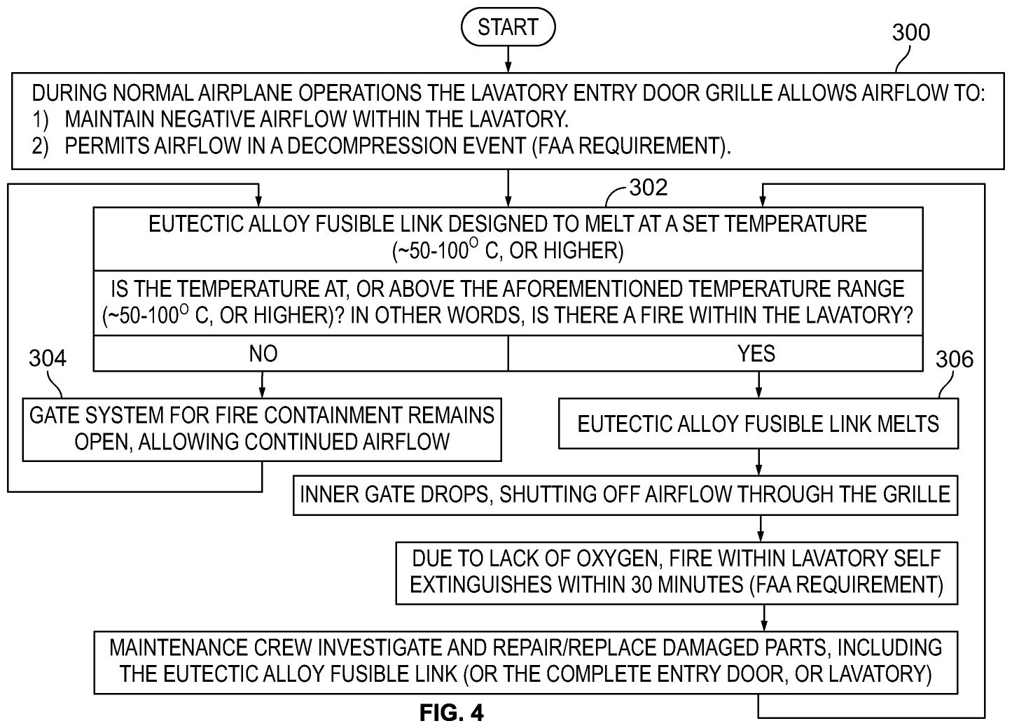

FIG. 4 illustrates a flow chart of a fire suppression method for a lavatory within an internal cabin of an aircraft, according to an embodiment of the present disclosure. Referring to FIGS. 3 and 4, at 300, during normal operations, the grille 202 allows airflow to maintain negative airflow within the lavatory and permit airflow in a decompression event. As such, the fire suppression system 200 within the grille 202 has the temperature-responsive device 210 in the first state, in which the first inner gate 204 and the second inner gate 206 are in an open position, such that one or more air channels pass therethrough.

At 302, in response to the predetermined temperature threshold being reached, the temperature-responsive device 210 transitions to the second state. For example, a eutectic alloy fusible link melts at the predetermined temperature threshold (for example, a temperature exceeding 50 degrees Celsius).

If the temperature has not reached the predetermined threshold, the fire suppression system 200 maintains the first inner gate 204 and the second inner gate 206 in the open position at 304. If, however, the temperature has reached the predetermined threshold, at 306, the temperature-responsive device 210 transitions to the second state (such as by melting), the second inner gate 206 drops, closes the air channel (thereby moving the gates 204 and 206 into a closed position), and thereby shuts off airflow through the grille 202.

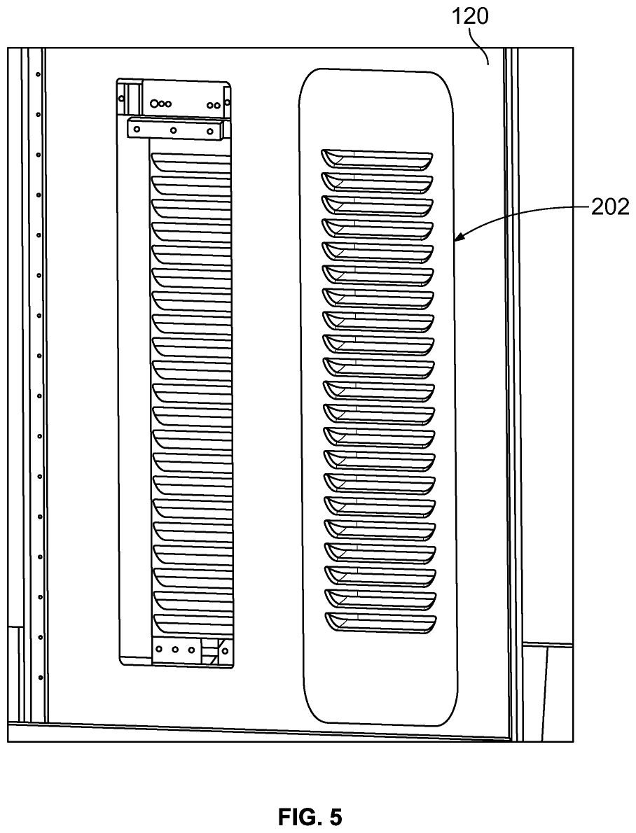

FIG. 5 illustrates an isometric front view of a door 120 having a grille 202, according to an embodiment of the present disclosure. The grille 202 includes a fire suppression system, as described herein. In at least one example, the door 120 is part of a lavatory, such as within an internal cabin of a vehicle (for example, a commercial aircraft).

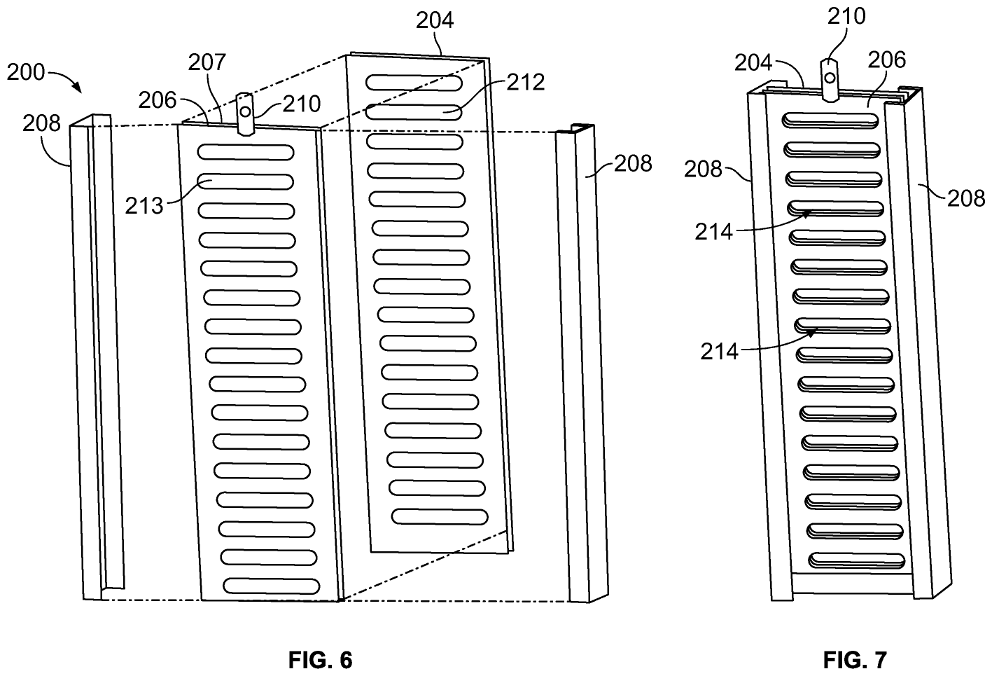

FIG. 6 illustrates an isometric exploded view of a fire suppression system 200, according to an embodiment of the present disclosure. FIG. 7 illustrates an isometric view of the fire suppression system of FIG. 6. Referring to FIGS. 6 and 7, the fire suppression system 200 includes the first inner gate 204, the second inner gate 206, the side guide channels 208, and the temperature-responsive device 210 (such as a eutectic fusible link) coupled to a fixed portion of the door (not shown in FIGS. 6 and 7) and the second inner gate 206, such as a top edge or portion 207 of the second inner gate 206. The first and second inner gates 204 and 206 include openings 212 (for example, first openings) and 213 (for example, second openings), respectively, that align to provide open air channels 214 that pass through the grille 202 when the temperature-responsive device 210 is in a first state (such as when the temperature is less than the predetermined temperature threshold).

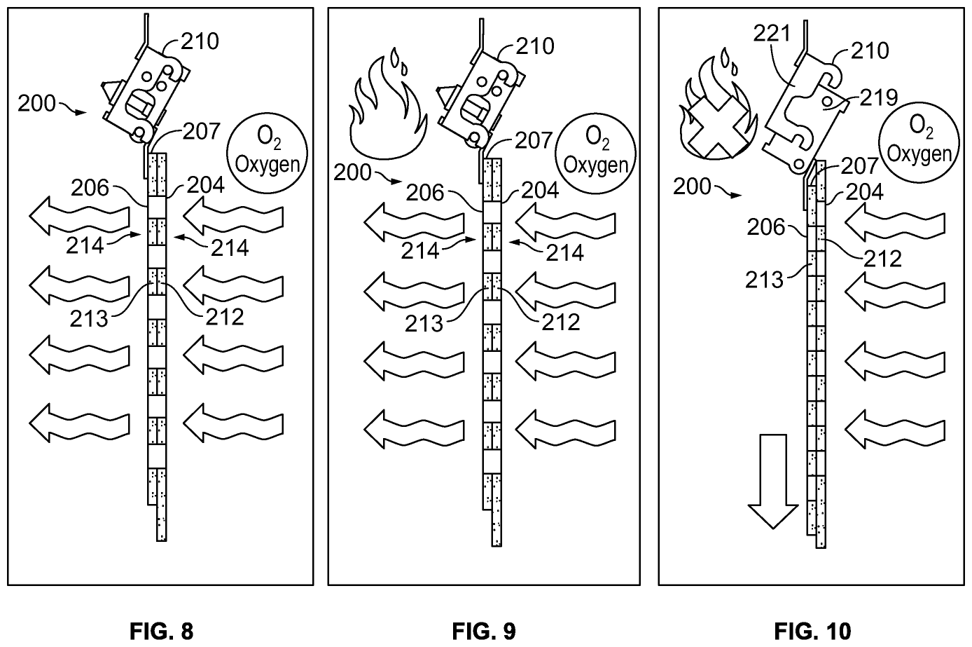

FIG. 8 illustrates a lateral view of the fire suppression system 200 having the temperature-responsive device in a first state during normal operation, according to an embodiment of the present disclosure. FIG. 9 illustrates a lateral view of the fire suppression system 200 as a predetermined temperature threshold is reached. FIG. 10 illustrates a lateral view of the fire suppression system 200 having the temperature-responsive device in a second state after the predetermined temperature threshold is reached.

As shown in FIG. 10, when the temperature-responsive device 210 transitions to the second state (such as having at least one portion that melts), the second inner gate 206 shifts downwardly in relation to the first inner gate 204, thereby mis-aligning the openings 212 and 213, and closing the open air channels 214 (shown in FIGS. 8 and 9, but are blocked in FIG. 10). For example, as the temperature-responsive device 210 transitions to the second state, a lower portion 219 of the temperature-responsive device 210 downwardly shifts in relation to a fixed upper portion 221, thereby forcing the second inner gate 206 downwardly, and mis-aligning the openings 212 and 213.

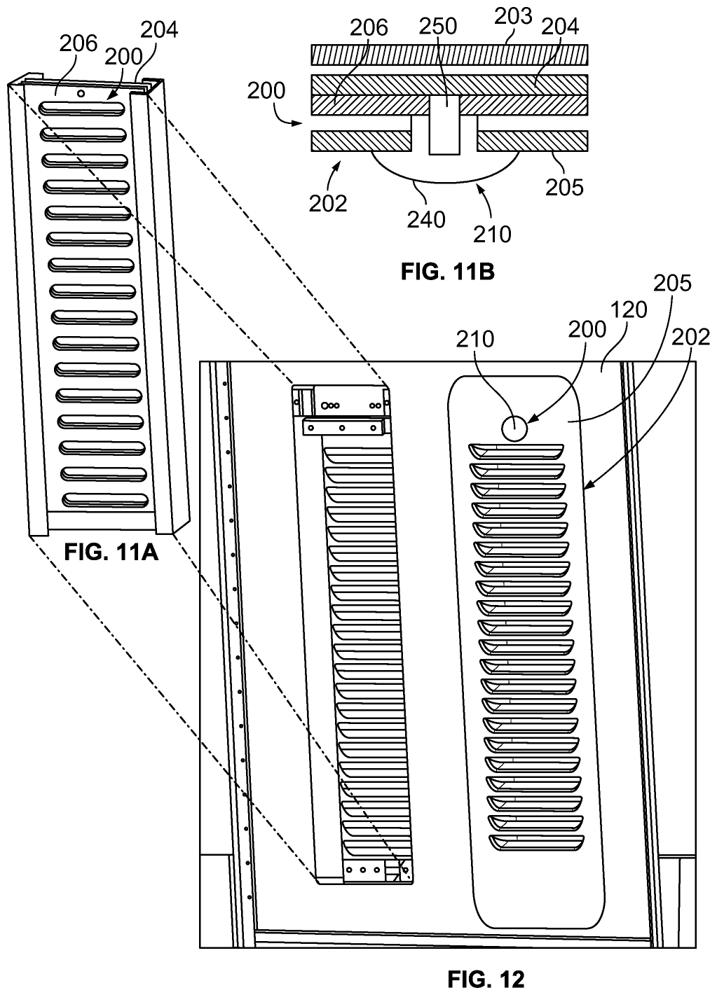

FIG. 11A illustrates an isometric view of a fire suppression system 200, according to an embodiment of the present disclosure. FIG. 11B illustrates a top edge view of the fire suppression system 200 of FIG. 11A. FIG. 12 illustrates an isometric view of a door 120 having the fire suppression system 200, according to an embodiment of the present disclosure.

Referring to FIGS. 11A, 11B, and 12, in this example, the temperature-responsive device 210 includes a button 240 (for example, a thermal conductive button, such as formed of copper, brass, or the like) secured to the grille 202 (such as the inner air grille 205 or optionally, the outer air grille 203), and a thermoplastic pin 250 extending into the button 240 and into the second inner gate 206. The pin 250 is configured to melt at the predetermined temperature threshold. When the pin 250 melts, the pin 250 disengages from the second inner gate 206 (for example, melts within and away from a retaining channel of the second inner gate 206). Consequently, the second inner gate 206 drops in relation to the first inner gate 204 to close off the open air channel.

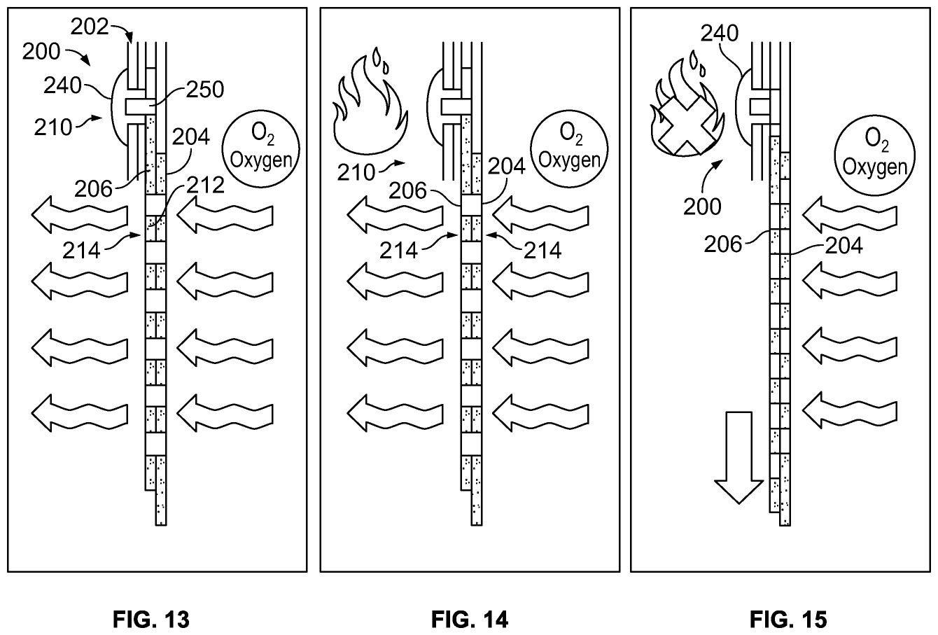

FIG. 13 illustrates a lateral view of the fire suppression system 200 having the temperature-responsive device 210 in a first state during normal operation, according to an embodiment of the present disclosure. FIG. 14 illustrates a lateral view of the fire suppression system 200 as a predetermined temperature threshold is reached, according to an embodiment of the present disclosure. FIG. 15 illustrates a lateral view of the fire suppression system 200 having the temperature-responsive device 210 in a second state after the predetermined temperature threshold is reached.

In at least one embodiment, the fire suppression system 200 can include the temperature-responsive device 210 shown and described with respect to FIGS. 6-10 and the temperature-responsive device 210 shown and described with respect to FIGS. 11A-15.

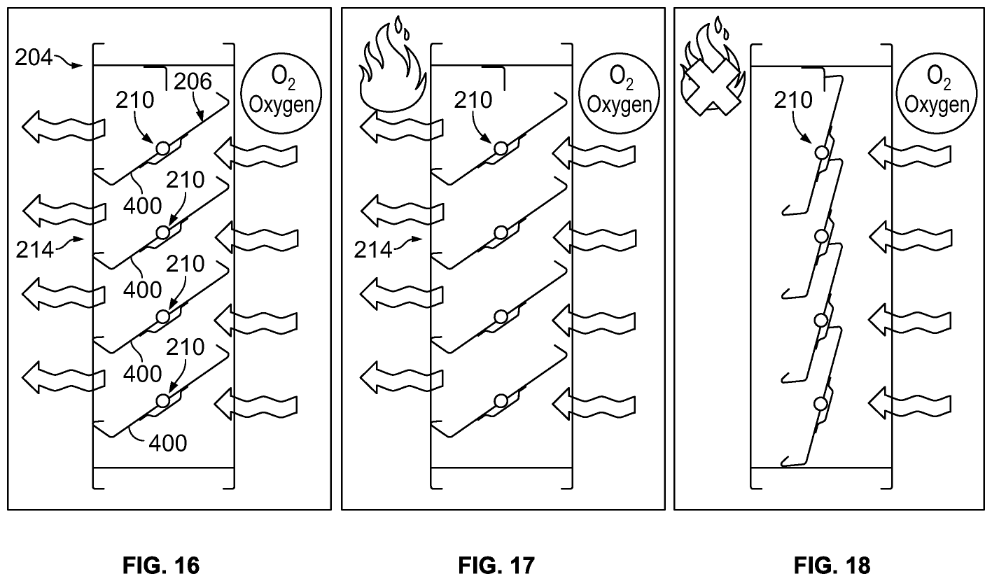

FIG. 16 illustrates a lateral view of the fire suppression system 200 having the temperature-responsive device 210 in a first state during normal operation, according to an embodiment of the present disclosure. FIG. 17 illustrates a lateral view of the fire suppression system 200 as a predetermined temperature threshold is reached, according to an embodiment of the present disclosure. FIG. 18 illustrates a lateral view of the fire suppression system 200 having the temperature-responsive device 210 in a second state after the predetermined temperature threshold is reached, according to an embodiment of the present disclosure.

In the example shown in FIGS. 16-18, the first inner gate 204 can be a fixed open frame, and the second inner gate 206 can be a moveable louver secured inside the fixed open frame. The temperature-responsive device 210 (such as any of those described herein) is coupled to the moveable louver, such as via a spring-loaded or stored energy device. As shown in FIG. 16, when the temperature-responsive device 210 is in the first state (below the predetermined temperature threshold), the panels of 400 the louver are oriented to form the air channels 214 through the fixed open frame and the louver. When the predetermined threshold is reached, the temperature-responsive device transitions to the second state, and, in response, the panels 400 of the louver move to close off the air channels 214, such that the louver is in the closed position shown in FIG. 18.

As shown, the moveable louver can include one or more panels 400 coupled to one or more temperature-responsive devices 210. The fire suppression system 200 can include more or less panels 400 and temperature-responsive devices 210 than shown in FIGS. 16-18.

In at least one embodiment, the fire suppression system 200 can include the temperature-responsive device 210 shown in FIGS. 16-18 and one or both of the temperature-responsive device 210 shown and described with respect to FIGS. 6-10 and/or the temperature-responsive device 210 shown and described with respect to FIGS. 11A-15.

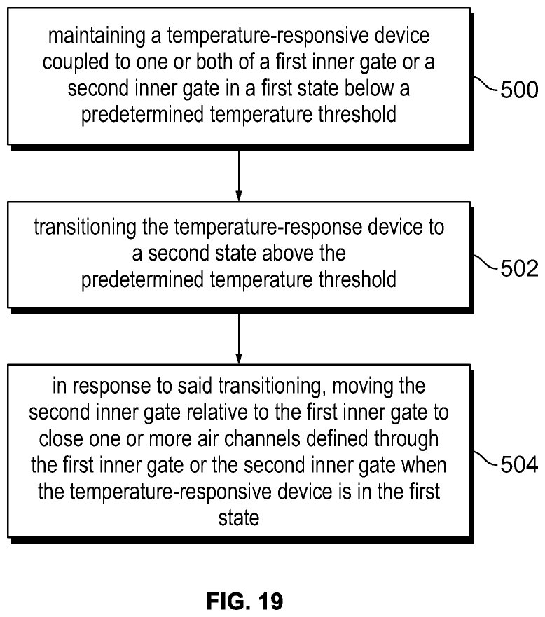

FIG. 19 illustrates a flow chart of a fire suppression method, according to an embodiment of the present disclosure. Referring to FIGS. 3 and 19, the fire suppression method includes maintaining 500 the temperature-responsive device 210 coupled to one or both of the first inner gate 204 or the second inner gate 206 in the first state below a predetermined temperature threshold; transitioning 502 the temperature-response device 210 to the second state above the predetermined temperature threshold; and in response to the transitioning 502, moving 504 the second inner gate 206 relative to the first inner gate 204 to close one or more air channels 214 (shown in FIG. 7, for example) defined through the first inner gate 204 or the second inner gate 206 when the temperature-responsive device 210 is in the first state.

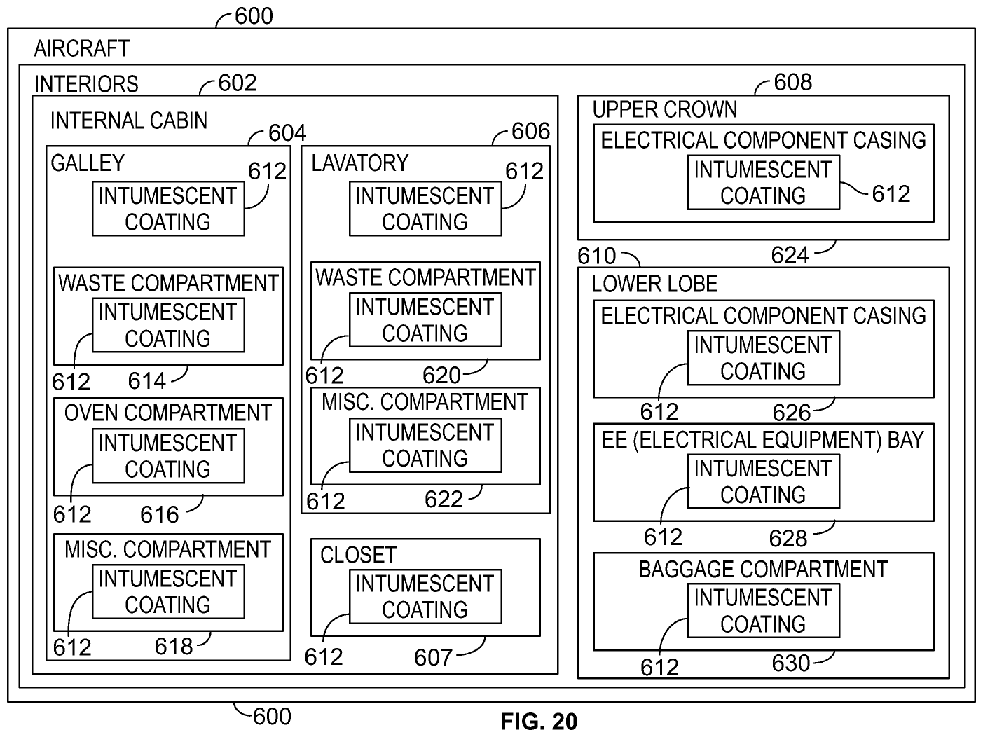

FIG. 20 illustrates a schematic block diagram of an aircraft 600, according to an example of the present disclosure. The aircraft 10 shown in FIG. 1 is an example of the aircraft 600. The aircraft 600 includes a plurality of enclosed components within an internal cabin 602. For example, the internal cabin 602 includes a galley 604, a lavatory 606, a closet 607, an upper crown 608, and a lower lobe 610. Various portions of the enclosed components include an intumescent coating 612. For example, one or more surfaces of the enclosed components can be coated with an intumescent material, thereby providing the intumescent coating 612.

As an example, the galley 604 includes an intumescent coating 612. A waste compartment 614 within the galley 604 includes an intumescent coating 612. An oven compartment 616 within the galley 604 includes an intumescent coating 612. A miscellaneous compartment 618 within the galley 604 includes an intumescent coating 612. Optionally, less than all of the shown enclosed components include an intumescent coating.

In at least one example, the lavatory 606 includes an intumescent coating 612. A waste compartment 620 within the lavatory 606 includes an intumescent coating 612. A miscellaneous compartment 622 within the lavatory 606 includes an intumescent coating 612. A grille system of a door within the lavatory 606 includes an intumescent coating 612.

In at least one example, the closet 607 includes an intumescent coating 612. As an example, an electrical component casing 624 within the upper crown 608 includes an intumescent coating 612. As an example, an electrical component casing 626 of the lower lobe 610 includes an intumescent coating 612. An electrical equipment bay 628 within the lower lobe 610 includes an intumescent coating 612. A baggage compartment 630 within the lower lobe 610 includes an intumescent coating 612.

In at least one example, at least a portion of an enclosed component can be formed of an intumescent material. In at least one, an entirety of an enclosed component can be integrally formed with an intumescent material. As an example one or more walls of a lavatory can be integrally formed with an intumescent material.

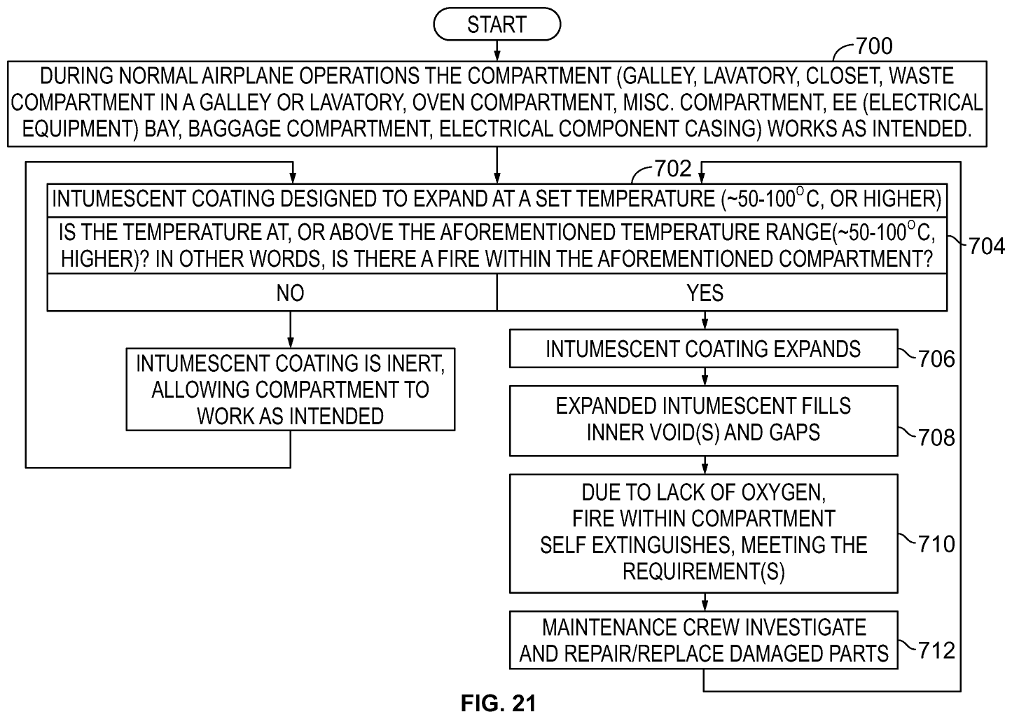

FIG. 21 illustrates a flow chart of a method of suppressing fire within an internal cabin of a vehicle, according to an example of the present disclosure. The internal cabin includes one or more enclosed components that include an intumescent coating. For example, the enclosed components can be compartments, such as galleys, lavatories, closets, waste compartments, oven compartments, and/or the like. The enclosed component operates in a normal fashion.

At 700, during normal operations, an enclosed component (such as a compartment) operates as intended. In at least one example, at 702, the intumescent coating is configured to expand when exposed to a predetermined temperature, such as 50-100 degrees Celsius or higher. If at 704 the temperature does not reach the predetermined temperature, the intumescent coating is inert, thereby allowing the enclosed component to operate as intended.

If, however, at 704, the predetermined temperature is reached, the intumescent coating expands at 706. As the intumescent coating expands, the expanding material of the intumescent coating fills inner voids, gaps, and the like of the enclosed component at 708. At 710, due to lack of oxygen, any fire within the enclosed component self-extinguishes. The component can then be inspected, repaired, and/or replaced at 712.

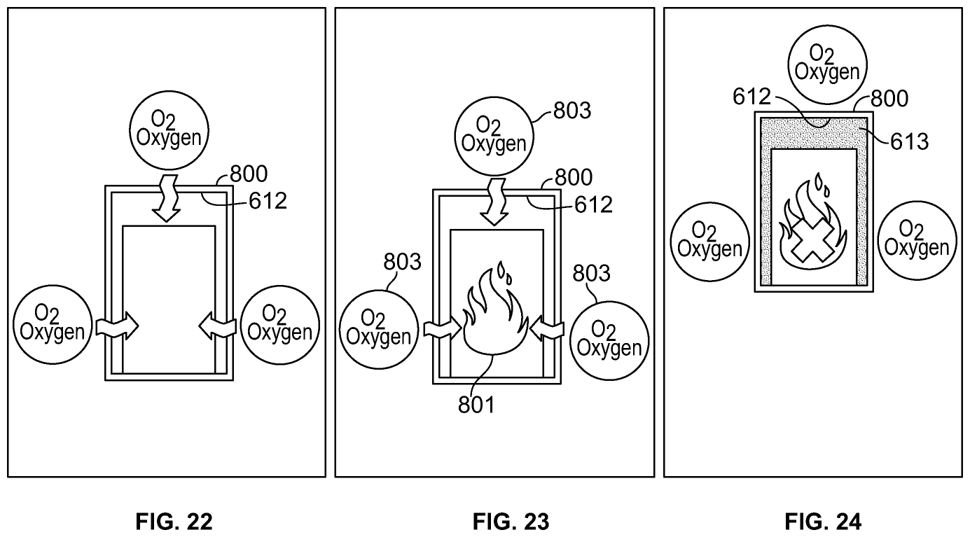

FIG. 22 illustrates a schematic block diagram of an enclosed component 800 (such as any of those described herein) in a normal state of operation, according to an example of the present disclosure. The enclosed component 800 includes an intumescent coating 612. For example, one or more interior surfaces of the enclosed component can be coated with an intumescent material, thereby providing the intumescent coating 612.

FIG. 23 illustrates a schematic block diagram of the enclosed component 800 as a fire ignites therein. The intumescent coating 612 is exposed to heat from a flame 801, and/or the flame 801 itself. At a predetermined temperature, the intumescent coating 612 expands to fill voids, gaps, and the like of the enclosed component 800 to stop the flow of oxygen 803 into the enclosed component 800.

FIG. 24 illustrates a schematic block diagram of the enclosed component 800 having the intumescent coating 612 in an expanded state. In response to being exposed to a temperature that meets or exceeds the predetermined temperature threshold, the intumescent coating 612 expands, thereby forming an expanded barrier 613 that fills gaps, holes, openings, voids, and/or the like, thereby depriving the fire of oxygen from outside the enclosed component 800. In at least one example, the expanded barrier 613 is an expanded char of the intumescent coating 612.

Examples of the enclosed components 800 include a galley, a lavatory, and a waste compartment. For example, interior surfaces of such enclosed components 800 can be coated within an intumescent coating, whether partially or entirely.

In an example, in the event of a fire, in the waste compartment, the intumescent coating expands (for example, chars) inside the waste compartment, thereby protecting the structural integrity of the surrounding honeycomb wall(s) (such as may only be rated to 160° F.), assisting in smothering the fire (closing out any air gaps), preventing the fire from spreading behind the waste compartment, galley/lavatory and beyond, and containing the fire to the accessible lavatory/cabin, where the fire can be extinguished with a fire extinguisher, for example.

In an example, a lavatory is an example of the enclosed component 800 that can include one or more intumescent coatings 612. For example, some or all painted surfaces inside of the lavatory can include the intumescent coating 612. In the event of a fire, anywhere inside the lavatory, the intumescent coating 612 expands, thereby protecting the structural integrity of the surrounding honeycomb wall(s), assisting in smothering the fire (closing out any air gaps around doors, etc.), and preventing the fire from spreading behind the lavatory and beyond.

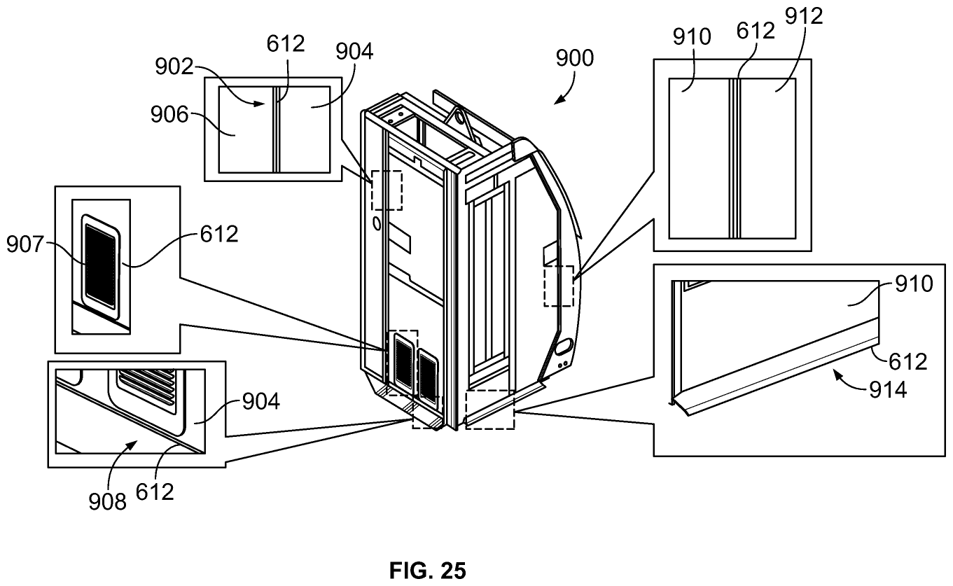

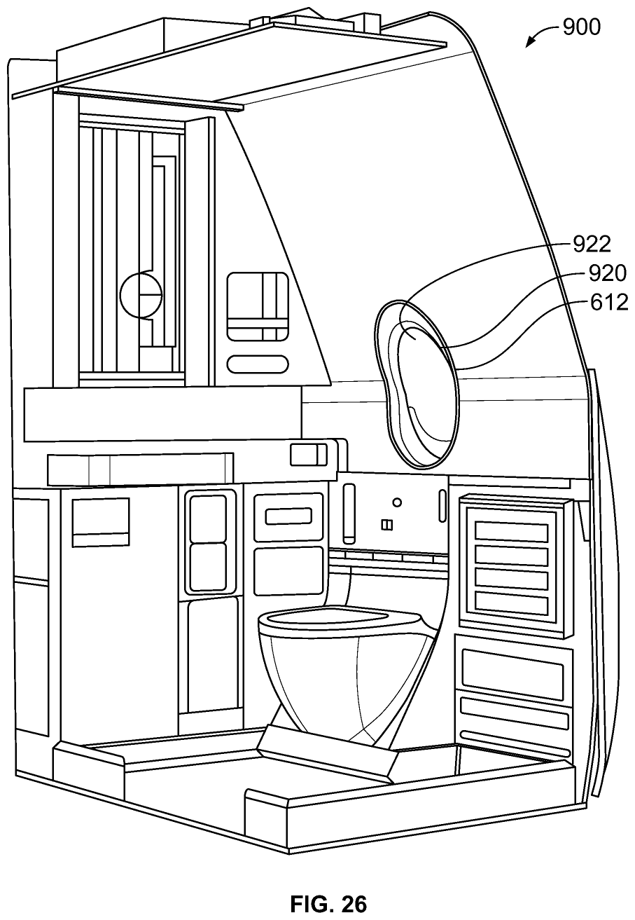

FIG. 25 illustrates an isometric external view of a lavatory 900, which is an example of an enclosed compartment. Various portions of the lavatory 900 can include an intumescent coating 612. For example, a gap 902 (that is, structure that defines the gap) between an entry door 904 and trim 906 can include an intumescent coating 612. A gap at a door grille 907 can include an intumescent coating 612. A gap between the entry door 904 and a threshold 908 can include an intumescent coating 612. A gap between a partition door 910 and trim 912 can include an intumescent coating 612. A gap between the partition door 910 and a threshold 914 can include an intumescent coating 612.

FIG. 26 illustrates an isometric interior view of the lavatory 900. Areas surrounding a window 920 can include an intumescent coating 612. Lavatories with windows may not pass fire containment requirements, due to the viewing tube that connects the lavatory window to the fuselage window. In at least one example, the viewing tube 922 can include an intumescent coating 612. In the event of a fire, inside the lavatory 900, the intumescent coating 612 expands inside and/or outside the viewing tube 922.

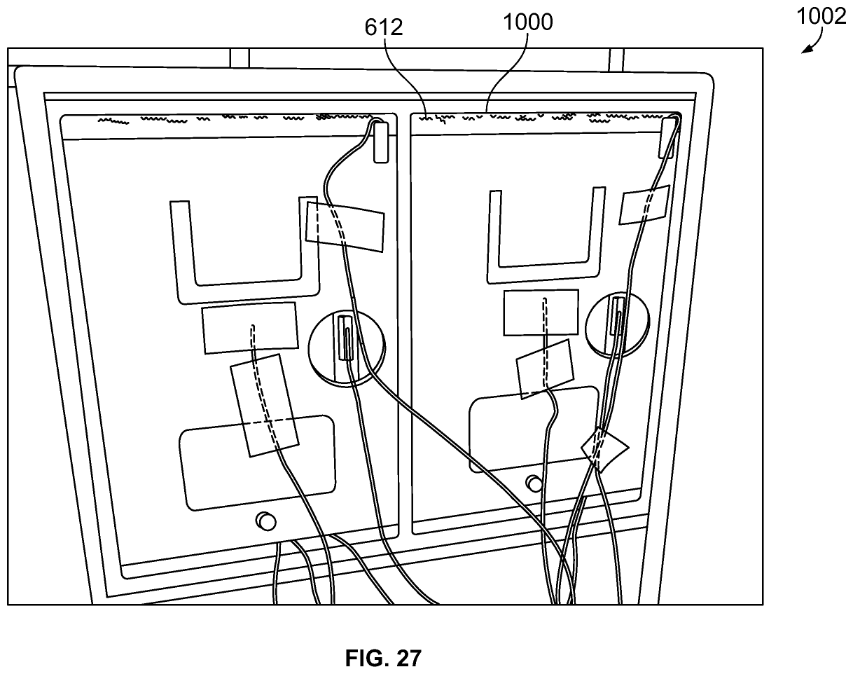

FIG. 27 illustrates a perspective view of an oven compartment 1000 within a galley 1002. In at least one example, the oven compartment 1000 can include an intumescent coating 612. For example, one or more internal and/or external surfaces of the oven compartment 1000 can be partially or entirely coated with an intumescent material, thereby forming the intumescent coating 612.

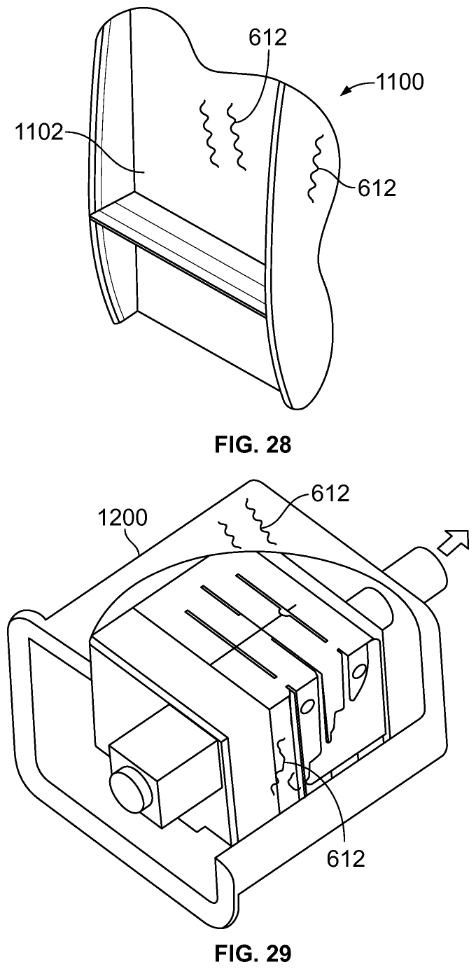

FIG. 28 illustrates an isometric view of an outboard face of a monument (for example, a galley, a lavatory, or the like) 1100 of an internal cabin. The monument 1100 (or sidewall) can form an interior wall portion within the internal cabin. One or more portions of the monument 1100 (or sidewall) can include an intumescent coating 612. For example, a portion or an entirety of an external surface 1102 of the monument 1100 can include an intumescent coating 612.

Coupled with existing smoke barriers (bulb or pillow seals) (or, in lieu of), outside faces of the monument 1100 can include an intumescent coating 612. In the event of a fire, in the lower lobe (for example), the intumescent coating 612 can supplement (or replace) the existing fire block and/or smoke barriers by expanding (charring), thereby aiding in fire suppression of a lower lobe fire. When activated (via heat from a fire) the intumescent coating 612 expands, with the resulting char working as a fire block and/or smoke barrier to prevent a chimney effect from occurring. The intumescent char closes out smaller voids that the fire block and/or smoke barrier may not otherwise be able to close.

FIG. 29 illustrates an isometric view of a battery box casing 1200. External and/or internal surfaces of the battery box casing 1200 can include an intumescent coating 612. The battery can be a lithium-ion battery having a plurality of lithium-ion cells. The intumescent coating 612 can be within the casing 1200.

Referring to FIGS. 1-29, various types of enclosed components can include an intumescent coating 612. Examples of such components include lavatories, galleys, sidewalls, lower lobes, upper crowns, trash cans, trash bags, ovens, electrical components (such as batteries), passenger bags, stowage bins, computers, smartphones, tables, E-cigarettes, powered scooters and wheelchairs, and the like.

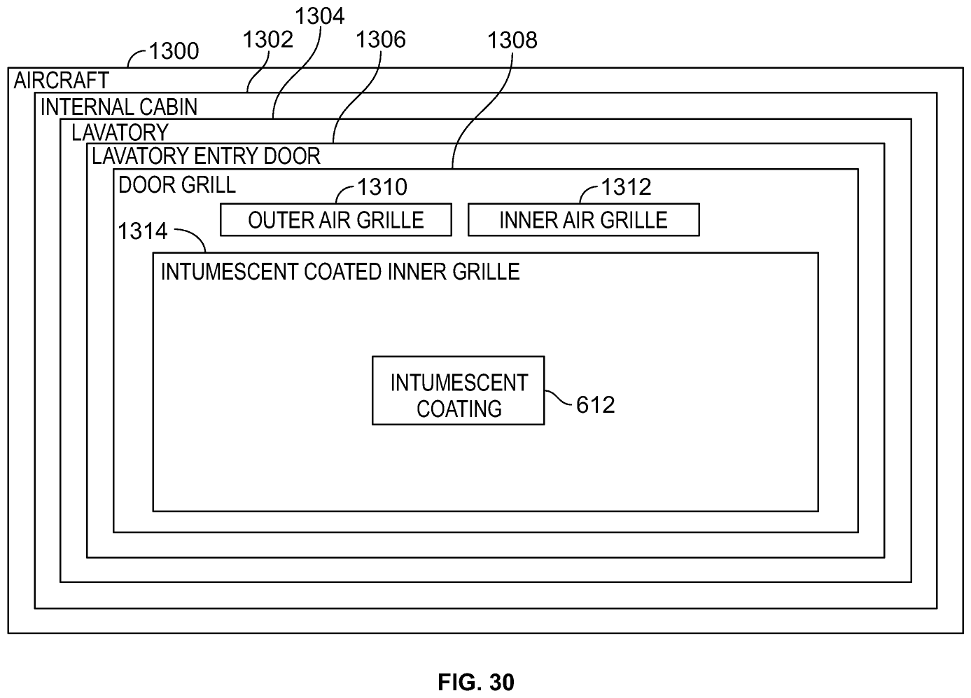

FIG. 30 illustrates a schematic block diagram of an aircraft 1300, according to an example of the present disclosure. The aircraft 10 shown in FIG. 1 and the aircraft 600 shown in FIG. 20 is an example of the aircraft 1300. The aircraft 1300 includes an internal cabin 1302. A lavatory 1304 is within the internal cabin 1302. The lavatory 1304 has a door 1306. The door 120 shown in FIG. 2 is an example of the door 1306. One or more portions of the lavatory 1304 can include an intumescent coating, as described herein.

For example, the door 1306 includes a door grille 1308. The door grille 1308 includes an outer air grille 1310 and an inner air grille 1312. An intumescent inner grille 1314 is disposed between the outer air grille 1310 and the inner grille 1312. The intumescent inner grille 1314 includes an intumescent coating 612.

In response to the intumescent coating 612 of the intumescent inner grille 1314 being exposed to a temperature that meets or exceeds the predetermined temperature threshold, the intumescent coating expands 612, as described herein. As an example, the center of the intumescent inner grille 1314 can experience temperatures at or exceed 850-900 degrees Celsius, for example, within a short period of time (such as 5 minutes) if a fire is in the lavatory. The intumescent coating 612 expands to fill air gaps within this period of time, thereby closing airflow into the lavatory.

Referring to FIGS. 5 and 30, for example, the door 120 has a grille assembly (or grille) 202, according to an example of the present disclosure. The grille 202 can include one or more components, surfaces, or the like having an intumescent coating, as described herein.

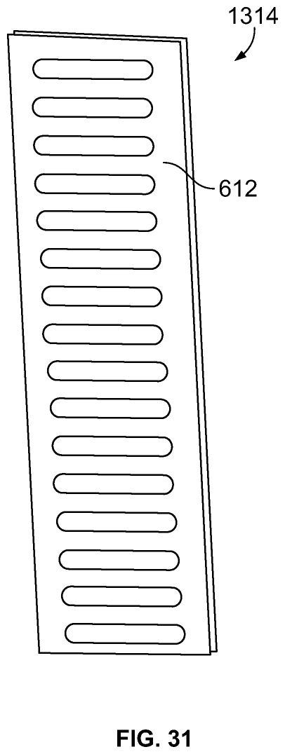

FIG. 31 illustrates a front view of an intumescent inner grille 1314, according to an example of the present disclosure. At least a portion of the intumescent inner grille 1314 includes the intumescent coating 612. In at least one example, an entirety of the intumescent grille 1314 is coated with intumescent material, thereby providing the intumescent coating 612 over an entire outer surface.

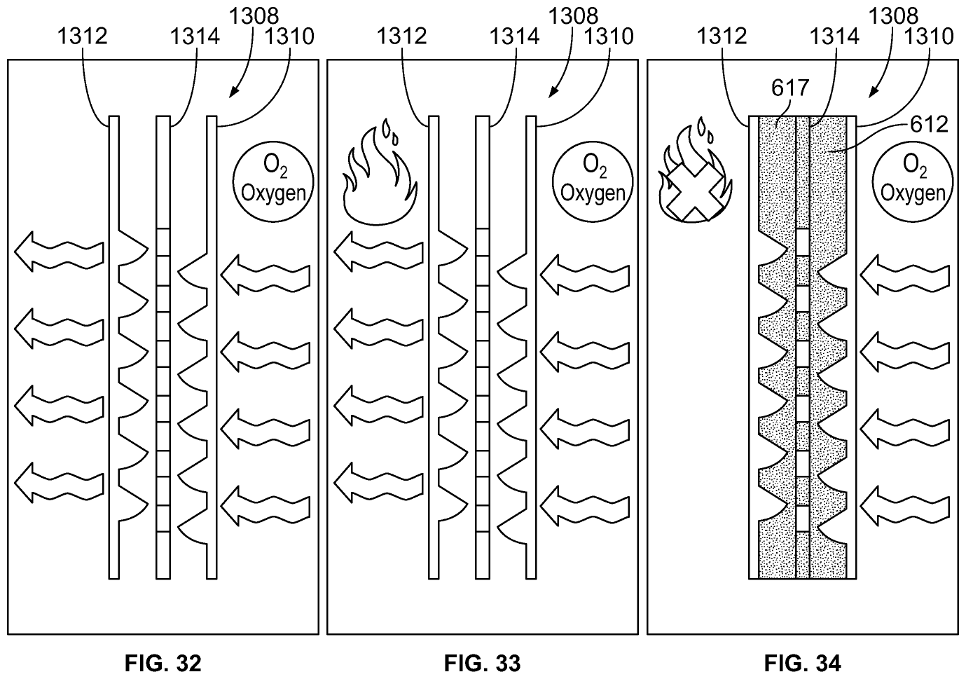

FIG. 32 illustrates a lateral view of a fire suppression system in a first state during normal operation, according to an example of the present disclosure. FIG. 33 illustrates a lateral view of the fire suppression system as a predetermined temperature threshold is reached, according to an example of the present disclosure. FIG. 34 illustrates a lateral view of the fire suppression system having the temperature-responsive device in a second state after the predetermined temperature threshold is reached, according to an example of the present disclosure.

Referring to FIGS. 32-34, when the intumescent inner grille 1314 (disposed between the outer grille 1310 and the inner grille 1312) is exposed to a temperature that meets or exceeds the predetermined temperature threshold, the intumescent coating 612 expands to form a gap-filling expanded char 617. Additionally, the outer grille 1310 and the inner grille 1312 can have inner faces coated with the intumescent coating 612.

FIGS. 32-34 show a louver grille system that provides two independent modes of operation specific to an aircraft. First, the louver grille system allows airflow in a decompression event, while also allowing airflow to maintain negative air pressure within the lavatory. Second, in a precise set of circumstances (predetermined temperature range) the system automatically changes state (closeout louver grille) to a fire suppression mechanism.

Further, the disclosure comprises examples according to the following clauses:

Clause 1. A vehicle comprising:
an internal cabin;
an enclosed component within the internal cabin,
wherein the enclosed component comprises an intumescent coating.

Clause 2. The vehicle of Clause 1, wherein the intumescent coating covers at least a portion of one or both of an internal or an external surface of the enclosed component.

Clause 3. The vehicle of Clauses 1 or 2, wherein the intumescent coating covers an entirety of the enclosed component.

Clause 4. The vehicle of any of Clauses 1-3, wherein the enclosed component is an oven compartment within a galley.

Clause 5. The vehicle of any of Clauses 1-3, wherein the enclosed component is a lavatory.

Clause 6. The vehicle of any of Clauses 1-3, wherein the enclosed component is a waste compartment within a lavatory.

Clause 7. The vehicle of any of Clauses 1-3, wherein the enclosed component is a grille within a door of a lavatory.

Clause 8. The vehicle of Clause 7, wherein the grille has an intumescent inner grille that includes the intumescent coating.

Clause 9. The vehicle of any of Clauses 1-3, wherein the enclosed component is at least a portion of a monument.

Clause 10. The vehicle of any of Clauses 1-3, wherein the enclosed component is a battery.

Clause 11. A fire suppression method for a vehicle, the fire suppression method comprising:

coupling an intumescent coating to an enclosed component within an internal cabin of the vehicle.

Clause 12. The fire suppression method of Clause 11, wherein said coupling comprises covering at least a portion of one or both of an internal or an external surface of the enclosed component with the intumescent coating.

Clause 13. The fire suppression method of Clauses 11 or 12, wherein said coupling comprises covering an entirety of the enclosed component with the intumescent coating.

Clause 14. The fire suppression method of any of Clauses 11-13, wherein the enclosed component is an oven compartment within a galley.

Clause 15. The fire suppression method of any of Clauses 11-13, wherein the enclosed component is a lavatory.

Clause 16. The fire suppression method of any of Clauses 11-13, wherein the enclosed component is a waste compartment within a lavatory.

Clause 17. The fire suppression method of any of Clauses 11-13, wherein the enclosed component is a grille within a door of a lavatory.

Clause 18. The fire suppression method of Clause 17, wherein the grille has an intumescent inner grille that includes the intumescent coating.

Clause 19. The fire suppression method of any of Clauses 11-13, wherein the enclosed component is at least a portion of a monument.

Clause 20. The fire suppression method of any of Clauses 11-13, wherein the enclosed component is a battery.

As described herein, examples of the present disclosure provide systems and methods for effectively and efficiently suppressing fire, such as within an enclosed component of a vehicle, such as a commercial aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A vehicle comprising:
an internal cabin;
an enclosed component within the internal cabin,
wherein the enclosed component comprises an intumescent coating.

2. The vehicle of claim 1, wherein the intumescent coating covers at least a portion of one or both of an internal or an external surface of the enclosed component.

3. The vehicle of claim 1, wherein the intumescent coating covers an entirety of the enclosed component.

4. The vehicle of claim 1, wherein the enclosed component is an oven compartment within a galley.

5. The vehicle of claim 1, wherein the enclosed component is a lavatory.

6. The vehicle of claim 1, wherein the enclosed component is a waste compartment within a lavatory.

7. The vehicle of claim 1, wherein the enclosed component is a grille within a door of a lavatory.

8. The vehicle of claim 7, wherein the grille has an intumescent inner grille that includes the intumescent coating.

9. The vehicle of claim 1, wherein the enclosed component is at least a portion of a monument.

10. The vehicle of claim 1, wherein the enclosed component is a battery.

11. A fire suppression method for a vehicle, the fire suppression method comprising:
coupling an intumescent coating to an enclosed component within an internal cabin of the vehicle.

12. The fire suppression method of claim 11, wherein said coupling comprises covering at least a portion of one or both of an internal or an external surface of the enclosed component with the intumescent coating.

13. The fire suppression method of claim 11, wherein said coupling comprises covering an entirety of the enclosed component with the intumescent coating.

14. The fire suppression method of claim 11, wherein the enclosed component is an oven compartment within a galley.

15. The fire suppression method of claim 11, wherein the enclosed component is a lavatory.

16. The fire suppression method of claim 11, wherein the enclosed component is a waste compartment within a lavatory.

17. The fire suppression method of claim 11, wherein the enclosed component is a grille within a door of a lavatory.

18. The fire suppression method of claim 17, wherein the grille has an intumescent inner grille that includes the intumescent coating.

19. The fire suppression method of claim 11, wherein the enclosed component is at least a portion of a monument.

20. The fire suppression method of claim 11, wherein the enclosed component is a battery.
